(19) United States
(12) Patent Application Publication
(10) Pub. No.: US 2019/0250436 A1
(43) Pub. Date: Aug. 15, 2019

(54) DISPLAY ASSEMBLY AND MANUFACTURING METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventor: Sikun HAO, Shenzhen (CN)

(21) Appl. No.: 16/023,952

(22) Filed: Jun. 29, 2018

Related U.S. Application Data
(63) Continuation of application No. PCT/CN2018/081662, filed on Apr. 3, 2018.

(30) Foreign Application Priority Data
Feb. 11, 2018 (CN) 201810142524.2

(51) Int. Cl. G02F 1/13; G02F 1/1343; G02F 1/133

(52) U.S. Cl. CPC G02F 1/1303; G02F 1/134309; G02F 2001/133302; G02F 1/13306; G02F 1/13439

(57) ABSTRACT

Disclosed are a display assembly and a manufacturing method thereof. The first glass substrate and the polymer stabilization vertical alignment machine metal stage are used to connect a driving circuit to receive a driving signal. The display assembly is used to generate a capacitive coupling effect between the first glass substrate and the second glass substrate with the driving signal to form a voltage difference. The liquid crystal molecules are arranged at a preset angle with the voltage difference. The display assembly is also used to receive incident light for curing the liquid crystal molecules. The embodiments are beneficial for reducing the driving traces of the panel and improving the utilization of the glass.

### CROSS-REFERENCE TO RELATED APPLICATION

This application is a continuing application of POT Patent Application No. PCT/CN2018/081662 entitled “Display assembly and manufacturing method thereof”, filed on Apr. 3, 2018, which claims priority to Chinese Patent Application No. 201810142524.2, filed on Feb. 11, 2018, both of which are hereby incorporated in its entireties by reference.

### FIELD OF THE INVENTION

The present application relates to a display field, and more particularly to a display assembly and a manufacturing method thereof.

### BACKGROUND OF THE INVENTION

At present, the display mode of the liquid crystal panel (LCD-TV) for television mainly utilizes a VA (Vertical Alignment) technology and an IPS (In Plane Switching) technology. VA technology includes a MVA (Multi-domain Vertical Alignment) technology and a PVA (Patterned Vertical Alignment) technology. These techniques have problems such as, low aperture ratio, poor contrast, slow response speed and complicated process due to the presence of domain boundaries such as protrusions and gaps.

### SUMMARY OF THE INVENTION

The embodiment of the present application provides a display assembly and a manufacturing method capable of reducing the driving traces of the panel and improving the utilization of the glass.

First, the embodiment of the present application provides a display assembly, comprising a polymer stabilization vertical alignment (PSVA) machine metal stage and a liquid crystal panel arranged on the polymer stabilization vertical alignment machine metal stage, wherein the liquid crystal panel comprises a first glass substrate, a second glass substrate, liquid crystal molecules arranged between the first glass substrate and the second glass substrate; the second glass substrate is arranged on the polymer stabilization vertical alignment machine metal stage;

the first glass substrate and the polymer stabilization vertical alignment machine metal stage are used to connect a driving circuit to receive a driving signal, and the display assembly is used to generate a capacitive coupling effect between the first glass substrate and the second glass substrate with the driving signal to form a voltage difference, and the liquid crystal molecules are arranged at a preset angle with the voltage difference; the display assembly is also used to receive incident light for curing the liquid crystal molecules.

In combination with the first aspect of the present application, in the first possible implementation of the first aspect of the present application, the liquid crystal panel further comprises a first electrode layer and a second electrode layer.

An inner surface of the first glass substrate is connected to an outer surface of the first electrode layer, and an inner surface of the first electrode layer is arranged with a first polyimide main chain and a first polyimide sub chain; an inner surface of the second glass substrate is connected to an outer surface of the second electrode layer; and an inner surface of the second electrode layer is arranged with a second polyimide main chain and a second polyimide sub chain, and the liquid crystal molecules are injected into a space formed between the first electrode layer and the second electrode layer; and an outer surface of the second glass substrate is connected to the polymer stabilization vertical alignment machine metal stage.

In combination with the first possible implementation of the first aspect of the present application, in the second possible implementation of the first aspect of the present application, a distance between the first glass substrate and the polymer stabilization vertical alignment machine metal stage is greater than a distance between the second glass substrate and the polymer stabilization vertical alignment machine metal stage.

In combination with the first possible implementation of the first aspect of the present application, in the third possible implementation of the first aspect of the present application, a range of the preset angle is from 0 degrees to 10 degrees.

In combination with the second possible implementation of the first aspect of the present application, in the fourth possible implementation of the first aspect of the present application, the first electrode layer and the second electrode layer are transparent electrodes.

In combination with the first possible implementation of the first aspect of the present application, in the fifth possible implementation of the first aspect of the present application, the display assembly further comprises monomer arranged between the first glass substrate and the second glass substrate, and the incident light is used to polymerize the monomer.

Second, the present invention provides a manufacturing method of a display assembly, comprising:

providing a polymer stabilization vertical alignment machine metal stage;

arranging a liquid crystal panel on the polymer stabilization vertical alignment machine metal stage, wherein the liquid crystal panel comprises a first glass substrate, a second glass substrate, liquid crystal molecules arranged between the first glass substrate and the second glass substrate; the second glass substrate is arranged on the polymer stabilization vertical alignment machine metal stage;

connecting the first glass substrate and the polymer stabilization vertical alignment machine metal stage to a driving circuit to receive a driving signal;

wherein the display assembly is used to generate a capacitive coupling effect between the first glass substrate and the second glass substrate with the driving signal to form a voltage difference, and the liquid crystal molecules are arranged at a preset angle with the voltage difference; the display assembly is also used to receive incident light for curing the liquid crystal molecules.

In combination with the second aspect of the present application, in the first possible implementation of the second aspect of the present application, the liquid crystal panel further comprises a first electrode layer and a second electrode layer,

and the method further comprises connecting an inner surface of the first glass substrate to an outer surface of the first electrode layer, wherein an inner surface of the first electrode layer is arranged with a first polyimide main chain and a first polyimide sub chain;

connecting an inner surface of the second glass substrate to an outer surface of the second electrode layer; wherein an inner surface of the second electrode layer is arranged with a second polyimide main chain and a second polyimide sub chain; the liquid crystal molecules are injected into a space formed between the first electrode layer and the second electrode layer;

connecting an outer surface of the second glass substrate to the polymer stabilization vertical alignment machine metal stage.

In combination with the second aspect of the present application, in the second possible implementation of the second aspect of the present application, the manufacturing method further comprises:

a distance between the first glass substrate and the polymer stabilization vertical alignment machine metal stage is greater than a distance between the second glass substrate and the polymer stabilization vertical alignment machine metal stage.

In combination with the second aspect of the present application, in the second possible implementation of the third aspect of the present application, the manufacturing method further comprises:

a range of the preset angle is from 0 degrees to 10 degrees.

Accordingly, in the embodiment of the present application, the first glass substrate and the polymer stabilization vertical alignment machine metal stage are used to connect a driving circuit to receive a driving signal. The display assembly is used to generate a capacitive coupling effect between the first glass substrate and the second glass substrate with the driving signal to form a voltage difference. The liquid crystal molecules are arranged at a preset angle with the voltage difference. The display assembly is also used to receive incident light for curing the liquid crystal molecules. It is beneficial for reducing the driving traces of the panel and improving the utilization of the glass.

### BRIEF DESCRIPTION OF THE DRAWINGS

The drawings related to the embodiments of the present application will be briefly described below.

FIG. 1 is a schematic diagram of a display assembly according to prior art;

FIG. 2 is a structural diagram of a display assembly disclosed in one embodiment of the present application;

FIG. 3 is a schematic diagram of a display assembly disclosed in one embodiment of the present application;

FIG. 4 is a flowchart of a manufacturing method of a display assembly disclosed in one embodiment of the present application;

FIG. 5 is a flowchart of a manufacturing method of a display assembly disclosed in another embodiment of the present application;

FIG. 6 shows one voltage driving manner of a manufacturing method of a display assembly disclosed in an embodiment of the present application;

FIG. 7 shows another voltage driving manner of a manufacturing method of a display assembly disclosed in an embodiment of the present application.

### DETAILED DESCRIPTION OF PREFERRED EMBODIMENTS

In order to enable persons skilled in the art to better understand the technical solution of the present application, embodiments of the present application are described in detail with the technical matters, structural features, achieved objects; and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained, should all be considered within the scope of protection of the present application.

Besides, the terminologies “first” and “second” in the specification, claims and aforesaid figures of the present application are used for distinguishing different objects but not for describing the specific sequence. Furthermore, the terms “including” and “having” and their any deformations are intended to cover non-exclusive inclusion. For example, a process, a method, a system, a product or a device comprising a series of steps or units which is not limited to the steps or units already listed, but optionally further comprises steps or units which are not listed, or optionally further comprises other steps or units which are inherent in these the process, the method, the product or the device.

Reference in this specification to “embodiment” means that a particular feature, structure, or characteristic described in connection with the embodiment is included in at least one embodiment of the present application. Appearances of the phrase “embodiment” in various places in the specification do not necessarily refer to the same embodiment, nor are separate or alternative embodiments mutually exclusive of other embodiments. Those skilled in the art implicitly and explicitly understand that the embodiments described herein may be combined with other embodiments.

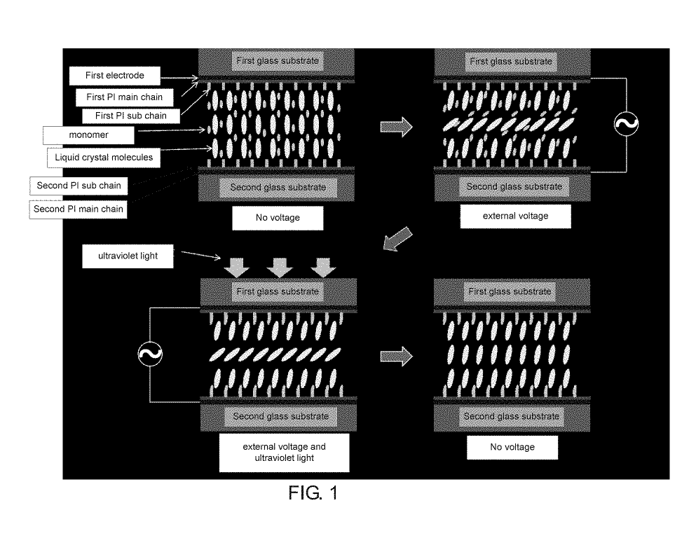

In the conventional design, the traditional light alignment process is shown in FIG. 1. A voltage is applied to the first electrode and the second electrode at two ends of the liquid crystal panel. After the alignment of the liquid crystal is regular, the liquid crystal panel is irradiated with ultraviolet light. The photosensitive monomer in liquid crystal has phase separation and is polymerized on the surface of PI (polyimide) sub chain. The orientation of liquid crystal molecules on the surfaces of PI main chain and PI sub chain is fixed. The liquid crystal molecules on the surface of the PI main chain and on the surface of the PI sub chain are arranged with a preset angle after the voltage is eliminated, thereby improving the response speed of the liquid crystals in the liquid crystal panel. As utilizing such light alignment manner, for providing the voltage to the transparent electrode at the upper glass substrate, a large number of traces need to be added on the large glass. This part of the traces decreases the utilization rate of the glass, which increases the production cost.

As regarding the aforesaid issue, the embodiment of the present application provides a display assembly, comprising a polymer stabilization vertical alignment (PSVA) machine metal stage and a liquid crystal panel arranged on the polymer stabilization vertical alignment machine metal stage. The liquid crystal panel comprises a first glass substrate, a second glass substrate, liquid crystal molecules arranged between the first glass substrate and the second glass substrate; the second glass substrate is arranged on the polymer stabilization vertical alignment machine metal stage; first, the first glass substrate and the polymer stabilization vertical alignment machine metal stage are used to connect a driving circuit to receive a driving signal, and second, the display assembly is used to generate a capacitive coupling effect between the first glass substrate and the second glass substrate with the driving signal to form a voltage difference, and at last, the liquid crystal molecules are arranged at a preset angle with the voltage difference; meanwhile, the display assembly is also used to receive incident light for curing the liquid crystal molecules.

The embodiment of the present application will be further described in detail with the accompanying drawings.

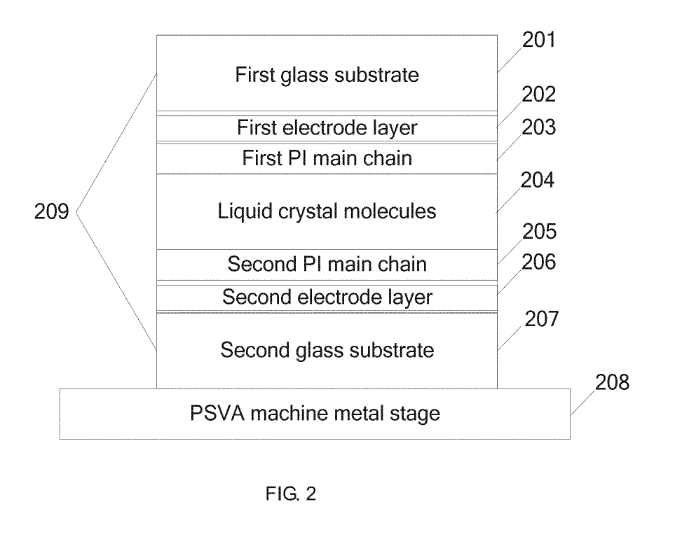

Please refer to FIG. 2. FIG. 2 is a structural diagram of a display assembly disclosed in one embodiment of the present application. As shown in FIG. 2, the display assembly comprises a polymer stabilization vertical alignment (PSVA) machine metal stage 208 and a liquid crystal panel 209 arranged on the PSVA machine metal stage 208. The liquid crystal panel 209 comprises a first glass substrate 201, a second glass substrate 207, liquid crystal molecules 204 arranged between the first glass substrate 201 and the second glass substrate 207; the second glass substrate 207 is arranged on the PSVA machine metal stage 208; wherein

the first glass substrate 201 and the polymer stabilization vertical alignment machine metal stage 208 are used to connect a driving circuit to receive a driving signal. The display assembly is used to generate a capacitive coupling effect between the first glass substrate 201 and the second glass substrate 207 with the driving signal to form a voltage difference. The liquid crystal molecules 204 are arranged at a preset angle with the voltage difference; the display assembly is also used to receive incident light for curing the liquid crystal molecules.

In one possible illustration, the liquid crystal panel further comprises a first electrode layer and a second electrode layer. An inner surface of the first glass substrate is connected to an outer surface of the first electrode layer; and an inner surface of the first electrode layer is arranged with a first polyimide main chain and a first polyimide sub chain; an inner surface of the second glass substrate is connected to an outer surface of the second electrode layer, and an inner surface of the second electrode layer is arranged with a second polyimide main chain and a second polyimide sub chain, and the liquid crystal molecules are injected into a space formed between the first electrode layer and the second electrode layer, and an outer surface of the second glass substrate is connected to the polymer stabilization vertical alignment machine metal stage.

The first polyimide main chain and the first polyimide sub chain constitute a first polyimide chain. The second polyimide main chain and the second polyimide sub chain constitute a second polyimide chain. The first polyimide chain is an upper chain and the second polyimide chain is a lower chain.

In one possible illustration, a distance between the first glass substrate and the polymer stabilization vertical alignment machine metal stage is greater than a distance between the second glass substrate and the polymer stabilization vertical alignment machine metal stage.

The upper and lower surfaces of the glass substrate are a color film substrate and an array substrate, respectively.

In one possible illustration, a range of the preset angle is from 0 degrees to 10 degrees.

In one possible illustration, the first electrode layer and the second electrode layer are transparent electrodes.

In one possible illustration, the display assembly further comprises monomer arranged between the first glass substrate and the second glass substrate, and the incident light is used to polymerize the monomer.

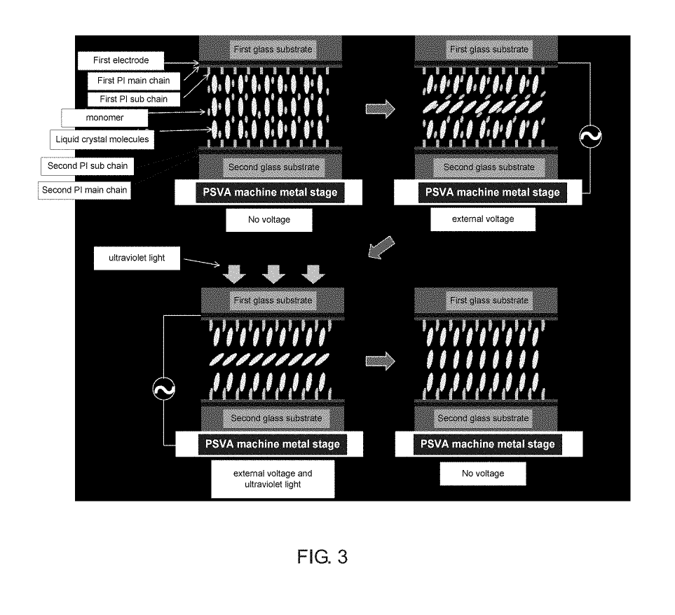

Optionally, the working principle of the display assembly in FIG. 2 is shown in FIG. 3. The working principle is: during the light alignment process, the voltage is applied to the first electrode in the liquid crystal panel and the PSVA machine metal stage. The voltage at two ends of the liquid crystals is generated by the coupling of the external driving voltage. After the liquid crystal alignment is regular, the liquid crystal panel is irradiated with ultraviolet light. The photosensitive monomer in the liquid crystal has phase separation and is polymerized on the surface of PI sub chain to fix the orientation of liquid crystal molecules on the surface of PI. The liquid crystal molecules on the surface of PI are arranged with a preset angle after the voltage is eliminated, thereby improving the response speed of the liquid crystal in the liquid crystal panel. It is beneficial for removing the aforesaid traces on the large glass and improving the utilization of the glass.

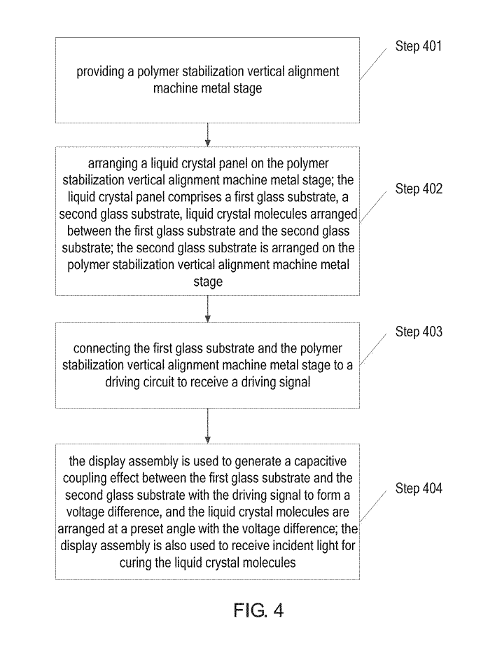

Please refer to FIG. 4. FIG. 4 is a flowchart of a manufacturing method of a display assembly disclosed in one embodiment of the present application. As shown in FIG. 4, the manufacturing method of the display assembly can comprises steps of:

Step S401, providing a polymer stabilization vertical alignment machine metal stage.

Step S402, arranging a liquid crystal panel on the polymer stabilization vertical alignment machine metal stage, wherein the liquid crystal panel comprises a first glass substrate, a second glass substrate, liquid crystal molecules arranged between the first glass substrate and the second glass substrate; the second glass substrate is arranged on the polymer stabilization vertical alignment machine metal stage.

Step 403, connecting the first glass substrate and the polymer stabilization vertical alignment machine metal stage to a driving circuit to receive a driving signal.

Step 404, the display assembly is used to generate a capacitive coupling effect between the first glass substrate and the second glass substrate with the driving signal to form a voltage difference, and the liquid crystal molecules are arranged at a preset angle with the voltage difference; the display assembly is also used to receive incident light for curing the liquid crystal molecules.

Optionally, the display assembly is used to first generate a capacitive coupling effect between the first glass substrate and the second glass substrate with the driving signal to form a voltage difference. At last, the liquid crystal molecules are arranged at a preset angle with the voltage difference; the display assembly is also used to receive incident light for curing the liquid crystal molecules. Thus, it is beneficial for reducing the driving traces of the panel and improving the utilization of the glass.

In one possible illustration, the liquid crystal panel further comprises a first electrode layer and a second electrode layer. An inner surface of the first glass substrate is connected to an outer surface of the first electrode layer; an inner surface of the first electrode layer is arranged with a first polyimide main chain and a first polyimide sub chain; an inner surface of the second glass substrate is connected to an outer surface of the second electrode layer, and an inner surface of the second electrode layer is arranged with a second polyimide main chain and a second polyimide sub chain; the liquid crystal molecules are injected into a space formed between the first electrode layer and the second electrode layer; an outer surface of the second glass substrate is connected to the polymer stabilization vertical alignment machine metal stage.

Thus, in this illustration, the liquid crystal panel is composed of a first glass substrate, a first electrode layer, a first PI main chain, a first PI sub chain, a second glass substrate, a second electrode layer, a second PI main chain and a second PI sub chain. The liquid crystal molecules are injected into the liquid crystal panel. With the voltage and irradiation of ultraviolet light, the liquid crystal molecules can be arranged at a preset angle and can be cured. Thus, it is beneficial for reducing the driving traces of the panel and improving the utilization of the glass to improve the response speed of the liquid crystal molecules in the liquid crystal cell.

In one possible illustration, a distance between the first glass substrate and the polymer stabilization vertical alignment machine metal stage is greater than a distance between the second glass substrate and the polymer stabilization vertical alignment machine metal stage.

The first glass substrate is an upper glass substrate, and the second glass substrate is a lower glass substrate.

In one possible illustration, a range of the preset angle is from 0 degrees to 10 degrees.

Thus, in this illustration, by adjusting the preset angle of the liquid crystal molecules to be controlled at a fixed angle, the response speed of the liquid crystal molecules in the liquid crystal cell can be advantageously improved.

In one possible illustration, the first electrode layer and the second electrode layer are transparent electrodes.

In one possible illustration, the display assembly is also used to receive incident light to polymerize the monomer.

Thus, in this illustration, the incident light is used to cure the liquid crystal molecules, which is beneficial for reducing the driving traces of the panel and improving the utilization of the glass.

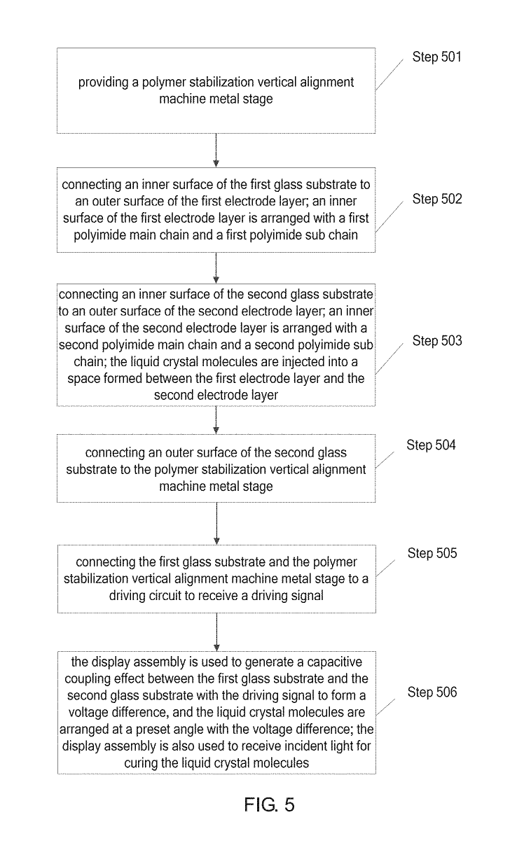

Please refer to FIG. 5. FIG. 5 is a flowchart of a manufacturing method of a display assembly disclosed in another embodiment of the present invention. As shown in FIG. 5, the manufacturing method of the display assembly can comprises the following steps.

Step S501, providing a polymer stabilization vertical alignment machine metal stage.

Step 502, connecting an inner surface of the first glass substrate to an outer surface of the first electrode layer, wherein an inner surface of the first electrode layer is arranged with a first polyimide main chain and a first polyimide sub chain.

Step 503, connecting an inner surface of the second glass substrate to an outer surface of the second electrode layer; wherein an inner surface of the second electrode layer is arranged with a second polyimide main chain and a second polyimide sub chain; the liquid crystal molecules are injected into a space formed between the first electrode layer and the second electrode layer.

Step 504, connecting an outer surface of the second glass substrate to the polymer stabilization vertical alignment machine metal stage.

Step 505, connecting the first glass substrate and the polymer stabilization vertical alignment machine metal stage to a driving circuit to receive a driving signal.

Step 506, the display assembly is used to generate a capacitive coupling effect between the first glass substrate and the second glass substrate with the driving signal to form a voltage difference, and the liquid crystal molecules are arranged at a preset angle with the voltage difference; the display assembly is also used to receive incident light for curing the liquid crystal molecules.

Optionally, the display assembly is used to first generate a capacitive coupling effect between the first glass substrate and the second glass substrate with the driving signal to form a voltage difference. At last, the liquid crystal molecules are arranged at a preset angle with the voltage difference; the display assembly is also used to receive incident light for curing the liquid crystal molecules. Thus, it is beneficial for reducing the driving traces of the panel and improving the utilization of the glass.

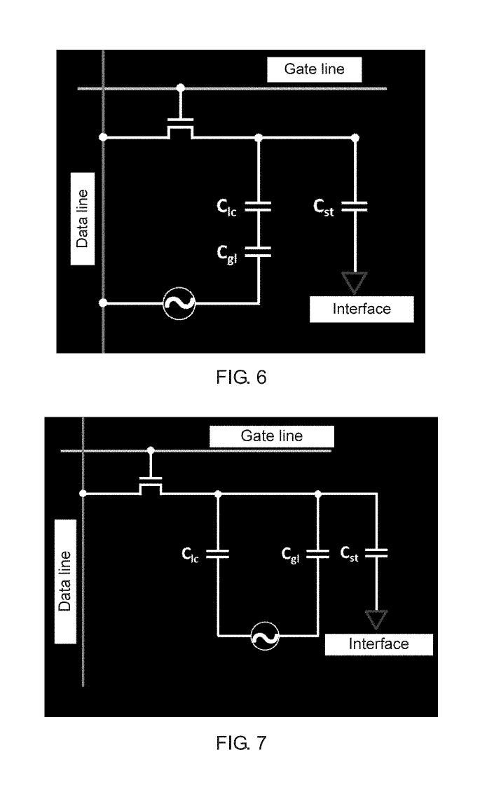

Please refer to FIG. 6. FIG. 6 shows one voltage driving manner of a manufacturing method of a display assembly disclosed in an embodiment of the present application. As shown in FIG. 6, C_{lc} is a transparent electrode capacitor. C_{gl} is a glass substrate capacitor. Cₛₜ is a storage capacitor. The voltage driving manner of the manufacturing method of the display assembly is that the transparent electrode capacitor and the glass substrate capacitor are coupled in series. A first end of the transparent electrode capacitor is coupled to a first end of the glass substrate capacitor. A second end of the transparent electrode capacitor is coupled to a source of the thin film transistor. A second end of the voltage generator is coupled to a data line. A first end of the storage capacitor is coupled to the source of the thin film transistor. A second end of the storage capacitor is coupled to an interface. The inner surface of the second glass substrate is a color film substrate. The color film substrate is connected to the outer surface of the second electrode. The outer surface of the second glass substrate is an array substrate. The array substrate is connected to the PSVA machine metal stage. The inner surface of the first glass substrate is an array substrate. The array substrate is connected to the outer surface of the first electrode.

In such driving manner, the external driving voltage is applied between the first glass electrode of the PSVA display assembly and the PSVA machine metal stage. With the coupling between the electrodes, the voltage difference generates at two ends of the liquid crystal to control the orientation of the liquid crystal molecules in the liquid crystal panel. After the alignment of the liquid crystal is regular, the liquid crystal cell is irradiated with ultraviolet light so that the liquid crystal molecules are arranged at a preset angle to improve the response speed of the liquid crystal molecules in the liquid crystal cell. It is beneficial for removing the aforesaid traces on the large glass and improving the utilization of the glass.

Please refer to FIG. 7. FIG. 7 shows another voltage driving manner of a manufacturing method of a display assembly disclosed in an embodiment of the present application. As shown in FIG. 7, C_{lc} is a transparent electrode capacitor. C_{gl} is a glass substrate capacitor. Cₛₜ is a storage capacitor. The voltage driving manner of the manufacturing method of the display assembly is that the transparent electrode capacitor and the glass substrate capacitor are coupled in series. A first end of the transparent electrode capacitor is coupled to a first end of the voltage generator. A first end of the glass substrate capacitor is coupled to a second end of the voltage generator. A second end of the transparent electrode capacitor is coupled to a source of the thin film transistor. A second end of the glass substrate capacitor is coupled to the source of the thin film transistor. A first end of the storage capacitor is coupled to the source of the thin film transistor. A second end of the storage capacitor is coupled to an interface. The inner surface of the second glass substrate is an array substrate. The array substrate is connected to the outer surface of the second electrode. The outer surface of the second glass substrate is a color film substrate. The color film substrate is connected to the PSVA machine metal stage. The inner surface of the first glass substrate is a color film substrate. The color film substrate is connected to the outer surface of the first electrode.

In such driving manner, the external driving voltage is applied between the first glass electrode of the PSVA display assembly and the PSVA machine metal stage. With the coupling between the electrodes, the voltage difference generates at two ends of the liquid crystal to control the orientation of the liquid crystal molecules in the liquid crystal panel. After the alignment of the liquid crystal is regular, the liquid crystal cell is irradiated with ultraviolet light so that the liquid crystal molecules are arranged at a preset angle to improve the response speed of the liquid crystal molecules in the liquid crystal cell. It is beneficial for removing the aforesaid traces on the large glass and improving the utilization of the glass.

The detail description has been introduced above for the display assembly and the manufacturing method provided by the embodiment of the invention. Herein, a specific case is applied in this article for explain the principles and specific embodiments of the present invention have been set forth. The description of the aforesaid embodiments is only used to help understand the method of the present invention and the core idea thereof; meanwhile, for those of ordinary skill in the art, according to the idea of the present invention, there should be changes either in the specific embodiments and applications but in sum, the contents of the specification should not be limitation to the present invention.

1: A display assembly, comprising a polymer stabilization vertical alignment (PSVA) machine metal stage and a liquid crystal panel arranged on the polymer stabilization vertical alignment machine metal stage, wherein the liquid crystal panel comprises a first glass substrate, a second glass substrate, liquid crystal molecules arranged between the first glass substrate and the second glass substrate;
wherein the second glass substrate is arranged on the polymer stabilization vertical alignment machine metal stage such that the polymer stabilization vertical alignment machine metal stage is located external of the liquid crystal panel; and
the first glass substrate and the polymer stabilization vertical alignment machine metal stage are connectable to a driving circuit to receive a driving signal, such that a capacitive coupling effect is caused between the first glass substrate and the second glass substrate with the driving signal to form a voltage difference, which sets the liquid crystal molecules at a preset angle; and the liquid crystal panel receives incident light applied thereto for curing the liquid crystal molecules; and
wherein the driving signal is applied between the first glass substrate and the polymer stabilization vertical alignment machine metal stage that is located external of the liquid crystal panel to generate capacitive coupling between the first and second glass substrates that are both arranged internal of the liquid crystal panel.

2: The display assembly according to claim 1, wherein the liquid crystal panel further comprises a first electrode layer and a second electrode layer, and an inner surface of the first glass substrate is connected to an outer surface of the first electrode layer, and an inner surface of the first electrode layer is arranged with a first polyimide main chain and a first polyimide sub chain; an inner surface of the second glass substrate is connected to an outer surface of the second electrode layer, and an inner surface of the second electrode layer is arranged with a second polyimide main chain and a second polyimide sub chain, and the liquid crystal molecules are injected into a space formed between the first electrode layer and the second electrode layer, and an outer surface of the second glass substrate is connected to the polymer stabilization vertical alignment machine metal stage.

3: The display assembly according to claim 1, wherein a distance between the first glass substrate and the polymer stabilization vertical alignment machine metal stage is greater than a distance between the second glass substrate and the polymer stabilization vertical alignment machine metal stage.

4: The display assembly according to claim 1, wherein a range of the preset angle is from 0 degrees to 10 degrees.

5: The display assembly according to claim 2, wherein the first electrode layer and the second electrode layer are transparent electrodes.

6: The display assembly according to claim 1, further comprising monomer arranged between the first glass substrate and the second glass substrate, and the incident light is used to polymerize the monomer.

7: A manufacturing method of a display assembly, comprising:
providing a polymer stabilization vertical alignment machine metal stage;
arranging a liquid crystal panel on the polymer stabilization vertical alignment machine metal stage, wherein the liquid crystal panel comprises a first glass substrate, a second glass substrate, liquid crystal molecules arranged between the first glass substrate and the second glass substrate; the second glass substrate is arranged on the polymer stabilization vertical alignment machine metal stage such that the polymer stabilization vertical alignment machine metal stage is located external of the liquid crystal panel;
connecting the first glass substrate and the polymer stabilization vertical alignment machine metal stage to a driving circuit to receive a driving signal;
wherein a capacitive coupling effect is caused between the first glass substrate and the second glass substrate with the driving signal to form a voltage difference, which sets the liquid crystal molecules at a preset angle; and the liquid crystal panel receives incident light applied thereto for curing the liquid crystal molecules; and
wherein the driving signal is applied between the first glass substrate and the polymer stabilization vertical alignment machine metal stage that is located external of the liquid crystal panel to generate capacitive coupling between the first and second glass substrates that are both arranged internal of the liquid crystal panel.

8: The manufacturing method according to claim 7, wherein the liquid crystal panel further comprises a first electrode layer and a second electrode layer,
and the method further comprises connecting an inner surface of the first glass substrate to an outer surface of the first electrode layer, wherein an inner surface of the first electrode layer is arranged with a first polyimide main chain and a first polyimide sub chain;
connecting an inner surface of the second glass substrate to an outer surface of the second electrode layer; wherein an inner surface of the second electrode layer is arranged with a second polyimide main chain and a second polyimide sub chain; the liquid crystal molecules are injected into a space formed between the first electrode layer and the second electrode layer;
connecting an outer surface of the second glass substrate to the polymer stabilization vertical alignment machine metal stage.

9: The manufacturing method according to claim 7, wherein a distance between the first glass substrate and the polymer stabilization vertical alignment machine metal stage is greater than a distance between the second glass substrate and the polymer stabilization vertical alignment machine metal stage.

102: The manufacturing method according to claim 7, wherein a range of the preset angle is from 0 degrees to 10 degrees.
